(19) United States
(12) Patent Application Publication
(10) Pub. No.: US 2007/0282905 A1
(43) Pub. Date: Dec. 6, 2007

(54) Communication terminals and methods for prioritizing the playback of distributed multimedia files

(75) Inventor: Lars Johan Ragnar Karlberg, Lund (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/447,374

(22) Filed: Jun. 6, 2006

(51) Int. Cl. G06F 17/00

(52) U.S. Cl. 707/104.1

(57) ABSTRACT

A communication terminal includes a communication module and a controller. The communication module is configured to communicate with other communication terminals over a interface. The controller is configured to establish a connection with a participant communication terminal via the communication module, to maintain a play list representing multimedia files to be played, to receive a participant multimedia file identification from the participant communication terminal, wherein the participant multimedia file identification corresponds to a participant multimedia file stored on the participant communication terminal, to add the participant multimedia file identification to the play list, to automatically prioritize the play list according to at least one criteria, and to thereafter execute playback of the multimedia files represented by the play list, including retrieving the participant multimedia file from the participant communication terminal for playback.

### FIELD OF THE INVENTION

The present invention relates to electronic devices and, more particularly, to electronic devices, methods and computer program products for playing multimedia files, such as audio files, video files, and/or image files.

### BACKGROUND

Electronic devices, such as wireless communication terminals (e.g., cellular telephones), are widely used to store and play back digital audio files. In addition, electronic devices may be used to store other types of multimedia files, such as digital image files and/or digital video files. Multimedia files may include any other type of file containing audio, visual or textual information. For example, as used herein, a “multimedia” file may include MMS or PPT message files in addition to or in place of typical multimedia files, such as audio, image and/or video files.

Digital audio files are typically stored in a compressed digital format, such as MP3, AIFF and/or other digital formats. Due to the limited amount of power available to mobile electronic devices, digital audio files are typically played back at a low power level via personal headphones and/or unpowered speakers which may permit only one, or a relatively few, people to listen to the audio file. Powered, amplified speakers and docking stations may be used to play audio files at higher power levels. However, such devices may be suitable only for particular hardware interfaces and/or may still be useful only for limited numbers of listeners.

Some mobile electronic devices include video screens and associated driving circuitry capable of displaying/playing digital image files and/or digital video files. However, due to the typical requirements of small size, low power and/or portability, mobile electronic devices typically include small video screens that may be suitable for viewing only by a single person, or at most very few people.

In view of the limitations of typical mobile electronic devices, a user of such a device may wish to play a multimedia file that is stored in the electronic device on another device, such as a media center (e.g., a PC or laptop, a television, an audio receiver, etc.). In other instances, a user of a mobile communication terminal may wish to play the multimedia file on another wireless communication terminal. This may be accomplished by connecting the electronic device to the other device via a cable or a wireless link (e.g., a Bluetooth connection) if the other device is equipped with a suitable communication module, which may be an integrated module or an auxiliary (e.g., plug-in) module. Multimedia files may be sent, one by one, from one or more mobile electronic devices to the playback device(s), which may be configured to play the multimedia files as they are received.

### SUMMARY

According to embodiments of the present invention, a communication terminal includes a communication module and a controller. The communication module is configured to communicate with other communication terminals over a communication interface. The controller is configured to establish a connection with a participant communication terminal via the communication module, to maintain a play list representing multimedia files to be played, to receive a participant multimedia file identification from the participant communication terminal and that identifies a participant multimedia file resident on the participant communication terminal, to add the participant multimedia file identification to the play list, to automatically prioritize the play list according to at least one criteria, and to thereafter execute playback of the multimedia files represented by the play list, including retrieving the participant multimedia file from the participant communication terminal for playback. In some embodiments, the communication terminal and/or the participant communication terminal may include wireless communication terminals.

The controller may be configured to automatically prioritize the play list based on metadata included in the multimedia file. For example, the controller may be configured to automatically prioritize the play list based on a comparison of date created, file format, file size, content rating, or genre associated with the multimedia files listed in the play list.

The controller may be configured to automatically prioritize the play list based on the tempo of the multimedia files and/or based on an identity of a user of the participant communication terminal.

The communication terminal may further include a database accessible by the controller and configured to store a rating of the user of the participant communication terminal, and the controller may be configured to update the rating of the user of the participant communication terminal based on feedback received from other communication terminals in response to playing a multimedia file submitted by the user.

The communication terminal may further include a database accessible by the controller and configured to store a rating of a multimedia file, and the controller may be configured to update the rating of the multimedia file based on feedback received from other communication terminals in response to playing the multimedia file.

The multimedia file may be received from the participant terminal in a first file format, and the controller may be further configured to convert the multimedia file to a second file format and to execute playback of the multimedia file in the second file format.

The controller may be configured to inspect the multimedia file to determine if it matches the description contained in the multimedia file identification and, if the multimedia file does not match the multimedia file identification, to remove the multimedia file from the play list.

The play list may include a first play list configured to list multimedia files of a first type, the controller may be further configured to maintain a second play list configured to list multimedia files of a second type, different from the first type. The controller may be further configured to play back multimedia files from the first play list and the second play list simultaneously. The controller may be further configured to alternate between play back of multimedia files from the first play list and the second play list.

The controller may be configured to establish a connection with a plurality of participant communication terminals, to receive a plurality of participant multimedia file identifications from the plurality of participant communication terminals, wherein each participant multimedia file identification corresponds to a respective participant multimedia file resident on a respective one of the plurality of participant communication terminals, to add each of the participant multimedia file identifications to the play list, and to retrieve the participant multimedia files from each of the respective participant communication terminals for playback.

According to some embodiments, the controller is configured to retrieve and execute the participant multimedia file from the participant communication terminal as a streaming file.

According to some embodiments, the controller is configured to retrieve the participant multimedia file from the participant communication terminal, to store the participant multimedia file on the communication terminal, and to thereafter execute playback of the stored participant multimedia file.

The controller may be configured to send a playback signal to a media center for playback of the multimedia files represented by the play list on the media center. At least one of the multimedia files may be received from the participant terminal in a first file format, and the controller may be further configured to convert the multimedia file to a second file format and to send the playback signal to the media center in the second file format. In some embodiments, the playback signal may include an analog signal.

According to some embodiments, the communication terminal includes a speaker and a display screen. The controller is configured to play the multimedia files represented by the play list using the speaker and/or the display screen.

The controller may be configured to send a playback signal to at least one participant communication terminal for playback of the multimedia files represented by the play list on the at least one participant communication terminal.

The controller may be configured to receive a multimedia file catalog listing from the participant communication terminal representing available multimedia files stored on the participant communication terminal, to receive user input selecting from the available multimedia files, and to add the selected available multimedia files to the play list.

According to some embodiments, the controller is configured to send a listing signal to the participant communication terminal representing the play list for display of the play list on the participant communication terminal.

According to some embodiments, the communication module is configured to communicate with other communication terminals over a direct point-to-point interface. The controller is configured to establish the connection with the participant communication terminal, receive the participant multimedia file identification from the participant communication terminal, and retrieve the participant multimedia file from the participant communication terminal for playback all via the direct point-to-point interface.

According to some embodiments, the communication module comprises a short range transmitter. The controller is configured to establish the connection with the participant communication terminal, receive the participant multimedia file identification from the participant communication terminal, and retrieve the participant multimedia file from the participant communication terminal for playback all via the short range transmitter. The short range transmitter may be a Bluetooth™ transmitter.

According to further embodiments of the present invention, methods for providing a multimedia file play list using a host communication terminal includes: establishing a connection between the host communication terminal and a participant communication terminal; maintaining a play list using the host communication terminal, the play list representing multimedia files to be played; receiving at the host communication terminal a participant multimedia file identification from the participant communication terminal, wherein the participant multimedia file identification corresponds to a participant multimedia file stored on the participant communication terminal; adding the participant multimedia file identification to the play list; automatically prioritizing the play list according to at least one criteria; and thereafter executing playback of the multimedia files represented by the play list, including retrieving the participant multimedia file from the participant communication terminal for playback.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a schematic diagram of a mobile wireless communication terminal according to some embodiments of the present invention and an exemplary base station transceiver.

FIG. 2 is a flowchart illustrating methods in accordance with some embodiments of the present invention.

FIG. 3 is a schematic diagram of a multimedia file playback system according to some embodiments of the present invention including the mobile wireless communication terminal of FIG. 1.

FIG. 4 is a schematic diagram illustrating a display of the mobile wireless communication terminal of FIG. 1 in accordance with some embodiments of the present invention.

FIG. 5 is a schematic diagram of a multimedia file playback system according to further embodiments of the present invention including the mobile wireless communication terminal of FIG. 1.

FIG. 6 is a schematic diagram of a multimedia file playback system according to further embodiments of the present invention including a media center host terminal.

FIG. 7 is a schematic diagram of a multimedia file playback system according to further embodiments of the present invention including the mobile wireless communication terminal of FIG. 1.

### DETAILED DESCRIPTION OF EMBODIMENTS OF THE INVENTION

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the term “comprising” or “comprises” is open-ended, and includes one or more stated features, integers, elements, steps, components or functions but does not preclude the presence or addition of one or more other features, integers, elements, steps, components, functions or groups thereof.

As used herein, the term “and/or” includes any and all combinations of one or more of the associated listed items.

As used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Furthermore, “coupled” or “connected” as used herein may include wirelessly coupled or connected.

Well-known functions or constructions may not be described in detail for brevity and/or clarity.

The present invention may be embodied as methods, electronic devices, and/or computer program products. Accordingly, the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

Embodiments according to the present invention are described with reference to block diagrams and/or operational illustrations of methods and communication terminals. In this regard, each block may represent a module, segment, or portion of code, which comprises one or more executable instructions for implementing the specified logical function(s). It is to be understood that each block of the block diagrams and/or operational illustrations, and combinations of blocks in the block diagrams and/or operational illustrations, can be implemented by radio frequency, analog and/or digital hardware, and/or program instructions. These program instructions may be provided to a controller, which may include one or more general purpose processors, special purpose processors, ASICs, and/or other programmable data processing apparatus, such that the instructions, which execute via the controller and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium include the following: hard disks, optical storage devices, magnetic storage devices, a portable computer diskette, a random access memory (RAM), a read-only memory (ROM), an erasable programmable read-only memory (EPROM or Flash memory), and a compact disc read-only memory (CD-ROM).

As used herein, “electronic component” means an active device as contrasted with a passive electrical connector or the like. An electronic component may include a processor.

As used herein, “streamed” or “streaming” means that a file, such as an audio or song file, is continuously sent via a digital signal to a receiving device where the audio or song file is concurrently played via a suitable receiving application. The digital signal is typically buffered.

As used herein, a “communication terminal” includes, but is not limited to, a terminal that is configured to receive/transmit communication signals via a wireline connection, such as via a public-switched telephone network (PSTN), digital subscriber line (DSL), digital cable, or another data connection/network, and/or via a wireless interface with, for example, a cellular network, a satellite network, a wireless local area network (WLAN), and/or another communication terminal.

When the communication terminal is configured to communicate over a wireless interface, it is referred to herein as a “wireless communication terminal” or a “wireless terminal.” Examples of wireless terminals include, but are not limited to, a cellular telephone, personal data assistant (PDA), pager, and/or a computer that is configured to communicate data over a wireless communication interface that can include a cellular telephone interface, a Bluetooth interface, a wireless local area network interface (e.g., 802.11), another RF communication interface, and/or an optical/infra-red communication interface.

As used herein, “mobile terminals” may be portable, transportable, installed in a vehicle (aeronautical, maritime, or land-based), or situated and/or configured to operate locally and/or in a distributed fashion at any other location(s) on earth and/or in space.

As used herein “play” and “playback” of a multimedia file is used in a general sense and may include playing an audio file over a speaker, displaying a digital image on a display screen and/or displaying a video file on a display screen and/or simultaneously playing an audio file associated with and/or embedded in the video file over a speaker.

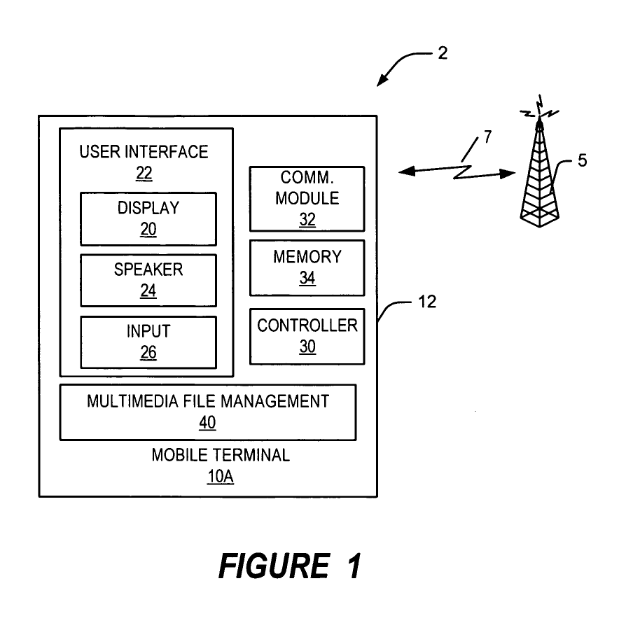

Some embodiments of the present invention will now be described below with respect to FIGS. 1-7. Some embodiments of the present invention provide host center devices capable of managing and playing multimedia files identified on a multimedia file play list including one or more multimedia file identifications. The multimedia files may be retrieved from one or more remotely located wireless communication terminals, and the host device may itself be a wireless communication terminal. Furthermore, the host device may be configured to permit automatic and/or manual prioritization of multimedia files in the multimedia file play list. The multimedia files may be played back at the host device and/or on a media center device associated with the host device.

Referring now to FIG. 1, an exemplary mobile wireless communication terminal 10A in accordance with some embodiments of the present invention is illustrated. It will be appreciated that although embodiments of the invention are illustrated in connection with a wireless communication terminal, the invention may include wired mobile and/or non-mobile communication terminals and methods. The wireless terminal 10A is configured to communicate data with one or more other wireless terminals over a direct wireless communication interface therebetween, over another wireless communication interface through one or more cellular base stations, and/or over another wireless communication interface through a wireless local area network (WLAN) router.

The wireless terminal 10A may be a mobile radiotelephone forming a part of a radiotelephone communication system 2 as illustrated in FIG. 1. The system 2 includes the mobile wireless communication terminal 10A and a base station transceiver, which is part of a wireless communications network 5. In some embodiments of the present invention, the network 5 includes a base station transceiver that includes the radio transceiver(s) that define an individual cell in a cellular network and communicates with the mobile terminal 10A (via an interface 7) and other mobile terminals in the cell using a radio-link protocol. It will be understood that, in some embodiments of the present invention, many base station transceivers may be connected through, for example, a mobile switching center and other devices to define the wireless communications network 5.

The mobile terminal 10A in the illustrated embodiments includes a portable housing assembly 12, a controller 30, a communication module 32, and a memory 34. The mobile terminal 10A further includes a user interface 22 (i.e., a man machine interface) including a display 20, a speaker 24 (i.e., a sound transducer), and at least one input device 26. The foregoing components of the mobile terminal 10A may be included in many conventional mobile terminals and their functionality is generally known to those skilled in the art. The mobile terminal 10A further includes a multimedia file management module 40, which may be stored in the memory 34.

The display 20 may be any suitable display screen assembly. For example, the display screen 28 may be a liquid crystal display (LCD) with or without auxiliary lighting (e.g., a lighting panel). In some cases the mobile terminal 10A may be capable of playing video content of a particular quality. For example, a mobile terminal 10A may be configured to display a video stream having a particular aspect ratio, such as 16:9 or 4:3. A number of standard video formats have been proposed for mobile terminals, including Quarter VGA (QVGA, 320×240 pixels), Common Intermediate Format (CIF, 360×288 pixels) and Quarter Common Intermediate Format (QCIF, 180×144 pixels). Moreover, some mobile terminals may have multiple display screens having different display capabilities. Thus, a mobile terminal 10A may be capable of displaying video in one or more different display formats.

The user interface 22 may include any suitable input device(s) including, for example, a touch activated or touch sensitive device (e.g., a touch screen), a joystick, a keyboard/keypad, a dial, a directional key or keys, and/or a pointing device (such as a mouse, trackball, touch pad, etc.). The speaker 24 generates sound responsive to an input audio signal. The user interface 22 can also include a microphone coupled to an audio processor that is configured to generate an audio data stream responsive to sound incident on the microphone.

The controller 30 may support various functions of the wireless terminal 10A. The controller 30 can be any commercially available or custom microprocessor, for example. In use, the controller 30 of the wireless terminal 10A may generate a display image on the display 20. In some embodiments, however, a separate signal processor and/or video chip (not shown) may be provided in the wireless terminal 10A and may be configured to generate a display image on the display 20.

The memory 34 is configured to store digital information signals and data such as a digital multimedia files (e.g., digital audio, image and/or video files).

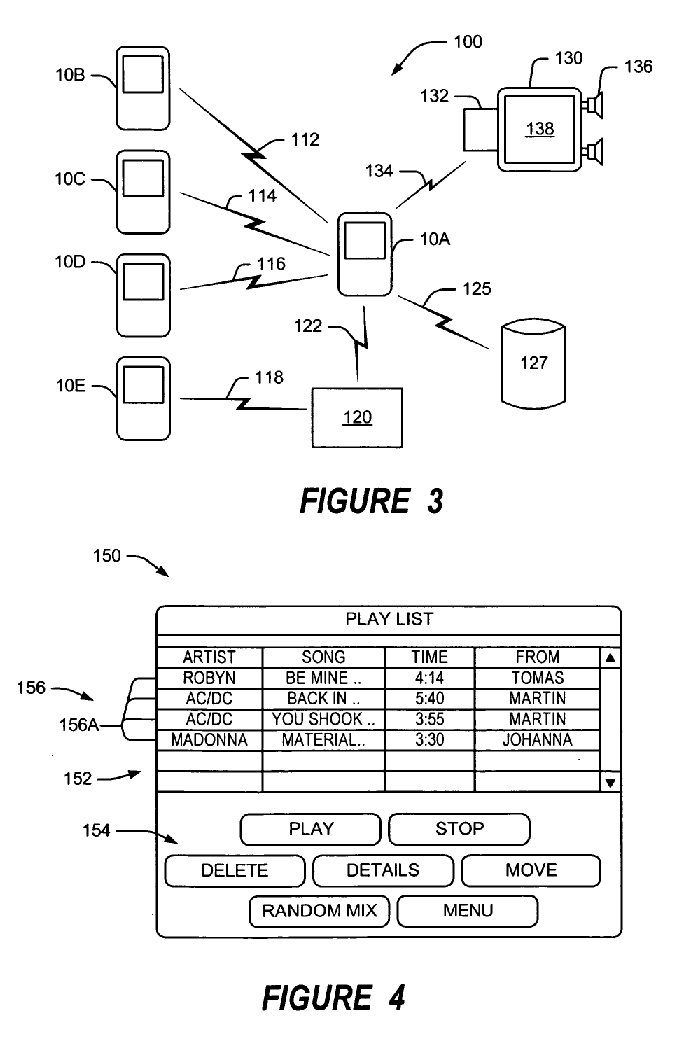

The communication module 32 is configured to communicate data over one or more wireless interfaces (e.g., wireless interfaces 7, 112, 114, 116, 122, and 134 as discussed herein (FIGS. 1 and 3)) to another remote wireless terminal as discussed herein. The communication module 32 can include a cellular communication module, a direct point-to-point connection module, and/or a WLAN module.

With a cellular communication module, the wireless terminal 10A can communicate via the base station(s) of the network 5 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The cellular base stations may be connected to a Mobile Telephone Switching Office (MTSO) wireless network, which, in turn, can be connected to a PSTN and/or another network.

A direct point-to-point connection module may include a direct RF communication module or a direct IR communication module. The direct RF communication module may include a Bluetooth module. With a Bluetooth module, the wireless terminal 10A can communicate via an ad-hoc network through a direct point-to-point interface.

With a WLAN module, the wireless terminal 10A can communicate through a WLAN (e.g., a router 120 (FIG. 3)) using a communication protocol that may include, but is not limited to, 802.11a, 802.11b, 802.11e, 802.11g, and/or 802.11i.

The communication module 32 can include a transceiver typically having a transmitter circuit and a receiver circuit, which respectively transmit outgoing radio frequency signals (e.g., to the network 5, a router or directly to another terminal) and receive incoming radio frequency signals (e.g., from the network 5, a router or directly to another terminal), such as voice and data signals, via an antenna. The communication module 32 may include a short range transmitter and receiver, such as a Bluetooth transmitter and receiver. The antenna may be an embedded antenna, a retractable antenna or any antenna known to those having skill in the art without departing from the scope of the present invention. The radio frequency signals transmitted between the wireless terminal 10A and the network 5, router or other terminal may include both traffic and control signals (e.g., paging signals/messages for incoming calls), which are used to establish and maintain communication with another party or destination. The radio frequency signals may also include packet data information, such as, for example, cellular digital packet data (CDPD) information. In addition, the transceiver may include an infrared (IR) transceiver configured to transmit/receive infrared signals to/from other electronic devices via an IR port.

The wireless terminal 10A may also be configured to electrically couple with another terminal via a wireline or cable for the transmission of digital communication signals therebetween. The wireless terminal 10A may include further components such as a camera device configured to generate a still image and/or video data stream based on incident light.

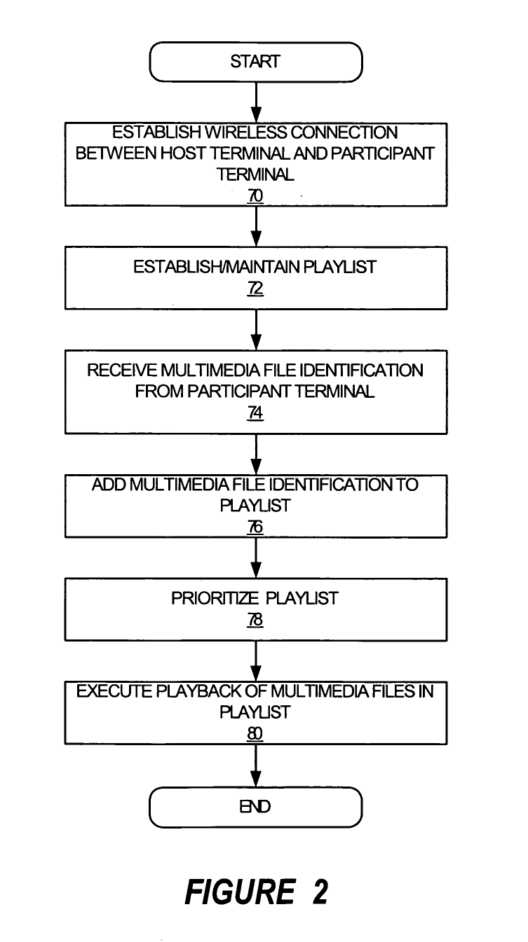

Methods for providing a multimedia file play list using a wireless communication terminal (e.g., the wireless terminal 10A) according to some embodiments of the present invention will now be described with reference to the flowchart of FIG. 2. Referring to the embodiments of FIG. 2, the methods include establishing a wireless connection between the host wireless communication terminal and a participant wireless communication terminal (Block 70). The host wireless communication terminal may include, for example, a wireless communication device having the capability of playing a multimedia file for a larger number of viewers/listeners than a typical handheld mobile terminal. For example, the host wireless communication terminal may include and/or be coupled to a large format display screen and/or high power speakers. However, in other embodiments, the host wireless communication terminal may include a handheld mobile terminal.

A play list is maintained using the host wireless communication terminal (Block 72). The play list represents multimedia files to be played. Separate play lists may be maintained at the host wireless communication terminal for different types of multimedia files. For example, the host wireless terminal may maintain separate play lists for audio files, video files, and/or still image files. The separate play lists may be managed separately at the host wireless terminal, which may, for example, play multimedia files from the separate play lists simultaneously, sequentially, and/or a combination of simultaneously and sequentially. For example, the host wireless communication terminal may be configured to display still images on a video screen while audio files are played on a speaker. Similarly, the host wireless communication terminal may include or be coupled to a dedicated video screen for displaying video files, while still images are simultaneously displayed on a separate still image display screen. In order to reduce interference between audio in audio files and audio in video files, the host wireless communication terminal may be configured to sequentially play audio and/or video files from the respective video and audio play lists, while simultaneously displaying still images from the still image play list.

A participant multimedia file identification from the participant wireless communication terminal is received at the host wireless communication terminal (Block 74). The participant multimedia file identification corresponds to or designates a participant multimedia file stored on the participant wireless communication terminal. The host wireless communication terminal determines the type of multimedia file represented by the multimedia file identification (Block 75). For example, the host wireless communication terminal determines if the multimedia file identification represents an audio file, a video file or a still image file. The participant multimedia file identification is then added to the corresponding play list (Block 76).

The play list may then be automatically prioritized by the multimedia file management module of the host terminal according to one or more prioritization criteria, as discussed in greater detail below (Block 78). Thereafter, playback of the multimedia files represented by the play lists is executed (Block 80). Execution of playback of the multimedia file includes retrieving the participant multimedia file from the participant wireless communication terminal for playback.

According to some embodiments, connections are established between the host wireless communication terminal and a plurality of participant wireless communication terminals, and the host wireless communication terminal receives a plurality of participant multimedia file identifications from the plurality of participant wireless communication terminals, adds each of the participant multimedia file identifications to the play list, and retrieves the participant multimedia files from each of the respective participant wireless communication terminals for playback. According to some embodiments, communication between the host wireless communication terminal and the participant wireless communication terminal is accomplished via a direct point-to-point interface, such as a Bluetooth wireless RF connection. According to some embodiments, communication between the host wireless communication terminal and the participant wireless communication terminal is accomplished via an indirect interface, such as through a WLAN or cellular-based system. Further aspects and embodiments of the present invention will be apparent from the following descriptions of further embodiments.

With reference to FIG. 3, a multimedia file playback system 100A according to embodiments of the present invention is shown therein. The system 100A includes the mobile wireless communication terminal 10A (also referred to herein as the “host wireless communication terminal” or “host terminal”), a plurality of additional participant wireless communication terminals 10B, 10C, 10D, and 10E (also referred to herein as the “participant wireless communication terminals” or “participant terminals”), and a media center 130.

The terminals 10B-E may be configured as described above with regard to the terminal 10A. The terminals 10B-E each include a wireless communication module 32 and a multimedia file management module 40. However, the respective multimedia file management modules may be differently configured for each terminal 10A-E depending on the intended functionality of the device. According to some embodiments, all or some of the terminals 10B-E are mobile wireless communication terminals. According to some embodiments, all or some of the terminals 10A-E are handheld mobile wireless communication terminals.

The media center 130 may include apparatus adapted to convert an audio signal (e.g., a digital audio signal) to a corresponding sound and/or apparatus to display still and/or moving images. The media center 130 may include, for example, a PC or laptop, a television, an audio receiver, stereo equipment, etc. The illustrated media center 130 includes a wireless communication module 132, one or more video display screens 138, and sound transducers (speakers) 136. The wireless communication module 132 may be integrated with the media center 130 or may be an auxiliary or plug-in wireless communication module such as the Bluetooth Media Viewer MMV-100 module or Bluetooth Media Viewer MMV-200 module, each available from Sony Ericsson of Sweden. While the host wireless communication terminal 10A and the media center 130 are shown as separate elements of the system 100 in FIG. 3, in some embodiments, the functionality of the host wireless communication terminal 10A may be provided in the media center 132, so that the media center 132 may communicate directly with the additional participant wireless communication terminals 10B-E.

The system 100A will now be described using an illustrative example of use. A group of users at a gathering each have a respective one of the terminals 10A-E. Various multimedia files are stored on one or more (typically two or more) of the terminals 10A-E. The users may wish to share multimedia files, including music videos, songs and/or still images, stored on their mobile terminals with the other users at the gathering by playing their multimedia files on the media center 130. With known and available technology, this can be accomplished by having each user send (via Bluetooth, etc.) his or her multimedia files (i.e., music audio files) to the media center 130 one at a time, file by file. However, this method may require substantial and active interaction from each contributing user. Such involvement may be inconvenient and/or not conducive to the setting (e.g., a party).

In accordance with embodiments of the present invention, the foregoing shortcomings can be overcome by creating and maintaining a play list of multimedia files and executing playback of the files using the host terminal 10A. Typically, each terminal 10A-E will have the appropriate multimedia file management module 40 (e.g., software or firmware application) installed thereon.

The host terminal 10A is chosen to be the master or host terminal and the participant terminals 10B-E are each designated as slave or participant terminals. The controller 30 of the host terminal 10A establishes a wireless connection (i.e., communicatively couples) with each of the participant terminals 10B-E. According to some embodiments the wireless connection is a direct wireless communication interface connection, according to some embodiments, a direct RF connection and, according to some embodiments, a Bluetooth connection. The connections may be established in known manner. For example, in the case of Bluetooth connections, the participant (slave) terminals 10B-E may be set to a searchable/discoverable state and the host (master) terminal 10A emits an inquiry to identify the available participant (slave) terminals 10B-E to form a piconet or personal area network.

As illustrated, the host terminal 10A communicates with the participant terminals 10B, 10C and 10D via direct point-to-point wireless interfaces or links 112, 114 and 116, respectively, and with the participant terminal 10E via wireless interfaces or links 118, 122 through a WLAN router 120. It will be appreciated that, according to some embodiments, the interfaces may be various combinations of wireless interfaces that are direct (e.g., Bluetooth) or indirect (e.g., via a WLAN router or a cellular network 5). According to some contemplated embodiments, all of the signals provided between the host terminal 10A and the participant terminals 10B-E to execute the multimedia file sharing procedure are provided via direct point-to-point wireless interfaces. According to some contemplated embodiments, all of the signals provided between the host terminal 10A and the participant terminals to execute the multimedia file sharing procedure are provided via direct wireless radio frequency (RF) interfaces such as Bluetooth interfaces.

Before or after establishing the connections, the host terminal 10A may identify and designate valid participant terminals by any suitable method. According to some embodiments, the host terminal 10A will poll or send an invitation to all or a selected group of potential participant terminals (e.g., those within operational range of the host terminal's Bluetooth signal). The potential participant terminals may then opt in by replying with an acceptance of the invitation. Alternatively or additionally, the host terminal 10A may accept unsolicited requests from participant terminals to participate. The host terminal 10A may be used to define specific groups such as a listing of the potential participant terminals that will be permitted to participate (i.e., contribute multimedia files to the play list). The host terminal 10A may also define the types of multimedia files that potential participant terminals will be permitted to submit.

In the embodiments illustrated in FIG. 3, the host terminal 10A is also communicatively coupled to the media center 130 to provide wireless multimedia file data signals via a wireless interface or link 134 to the communication module 132. Alternatively, the host terminal 10A can be connected to the media center 130 using a wireline or signal cable. As discussed above, the media center 130 may itself act as a host terminal that is configured to query potential participants and/or accept participation requests directly and/or indirectly from participant mobile terminals.

Once the connections are established between the host terminal 10A and the participant terminals 10B-E, each participant can send one or more participant multimedia file identification(s) designating a corresponding multimedia file stored on the participant's terminal 10B-E. In addition or in the alternative, the host terminal 10A can poll the participant terminals 10B-E to obtain a list of one or more available multimedia files stored on the participant terminals 10B-E. The multimedia file management module 40 of the sending participant terminal 10B-E may provide a user interface to facilitate the selection and sending of the multimedia file identification(s). For example, the module 40 may generate a list of the available stored multimedia files and check boxes for selecting the multimedia file(s) to send to the host terminal 10A. In addition or in the alternative, multimedia files that the user of a participant terminal 10B-E wishes to share with the host terminal may be stored in a designated folder or directory, such as a shared folder or directory. In that case, it may not be necessary for the user of the participant terminal 10B-E to designate files to be shared each time a connection is made to a host terminal 10A.

The host terminal 10A receives the participant multimedia file identifications from the participant terminals 10B-E and determines the type of multimedia file that each of the multimedia file identifications represents. This may be accomplished, for example, by inspecting a file type suffix for the file name. In some embodiments, the multimedia file identification includes an explicit indication of the type of multimedia file represented thereby. The multimedia file management module 40 of the host terminal 10A creates and maintains a host play list of these multimedia file identifications for each type of multimedia file that is accepted by the host terminal 10A. If the multimedia file identification represents a type of multimedia not supported by the host terminal 10A and/or the media center 130, the host terminal 10A may return an error message to the participant terminal 10B-E that submitted the multimedia file identification. The host play list represents multimedia files to be played at the host terminal 10A and/or at an associated media center 130.

Each multimedia file management module 40 may provide a display 150 on the associated terminal 10A-E as shown in FIG. 4. The display provided on the host terminal 10A may differ from the display provided on the participant terminals 10B-E. For example, the portions of the display 150 related to management functionality may be omitted from the participant terminal displays. Alternatively, the multimedia file management module 40 may provide no display on the participant terminals 10B-E.

In the illustrated embodiment, the display 150 includes a play list field 152 and control buttons 154 (e.g., soft keys). The control buttons 154 will typically only be displayed on the host terminal display. An exemplary audio file play list 156 is displayed in the play list field 152. The play list 156 includes a row-by-row series of multimedia file identifications 156A, each corresponding to a respective multimedia file. In the case of an audio file, each multimedia file identification may includes an artist, a name, and a play time corresponding to the associated multimedia file, as well as an identification of the participant that has submitted the multimedia file identification. It will be appreciated that more, less and/or different information may be provided as well.

The host may selectively manage play of the multimedia files represented by the multimedia file list 156 using the control buttons 154, for example. For example, the “PLAY” and “STOP” buttons may be used to start and stop transmission of the multimedia files to the media center 130. The “MOVE” button may be used to manually change the order of the multimedia file identifications 156A in the play list 156 (i.e., to change the order in which the associated multimedia files will be played). The “DELETE” button may be used to delete a multimedia file identification 156A from the play list 156. The “DETAILS” button may be used to display additional information about a file identified by a multimedia file identification 156A. The “RANDOM MIX” button may be used to cause the host terminal 10A to execute playback of the multimedia files (i.e., send the multimedia files to the media center 130) in a random or other non-sequential order.

Other functionality could also be provided. For example, the host terminal 10A may allow the user to change the order of the multimedia file identifications 156A according to one or more selected attributes (e.g., contributing participant, multimedia file length, etc.). The host terminal 10A may be configured to designate which of the participant terminals 10B-E are permitted to add multimedia file identifications to the play list 156. The participant terminals 10B-E may be enabled to edit or modify the multimedia file list 156 in addition to adding multimedia file identifications. In this case, the host terminal 10A may be configured to allow the host to select which of the participant terminals 10B-E are and are not authorized to modify the multimedia file play list 156 (i.e., enable and disable the play list edit capability of the participant terminals).

In some embodiments of the invention, the host terminal 10A is configured to automatically manage the order of the play list. For example, the host terminal 10A may be configured to automatically re-order multimedia file identifications in a particular play list based on preferences set by a user of the host terminal 10A.

In particular, the host multimedia file management module may be configured to alter the order of the play lists from the order in which the multimedia file identifications were received from the participant mobile terminals 10B-E. In some cases, the multimedia file management module 40 of the host terminal 10A may be configured to completely omit certain media files based one or more criteria. For example, the multimedia file management module may determine that a certain play order would be more suitable (based on artistic preferences). Further, the multimedia file management module may omit a file from the play list if it is determined that the file is inappropriate to be played. For example, an audio or video file may have a rating associated therewith that identifies an appropriate audience for the file (such as E for everyone, T for teen, A for adult, etc.). The rating may be stored as metadata in the audio file and/or the rating may be retrieved by the host terminal 10A from the remote or local database 127 based on information provided in the multimedia file identification. The user of the host terminal 10A may establish an acceptable rating, and if a file identified in a multimedia file identification exceeds the acceptable rating, the file may be removed/excluded from the play list.

In some embodiments, automatic prioritization of play lists may be based on characteristics assigned to the media files and the participating users, and/or based on a set of principles that can be created and followed by the host terminal 10A.

In particular embodiments, the host terminal 10A is configured such that automatic prioritization may be turned on and off, and/or such that different operating profiles may be selected by the user depending on the type of prioritization desired.

Prioritization may be performed using any available metadata relating to a multimedia file, such as date created, file format, file size, orientation (for images), classification (for music, e.g. classical, hard rock etc.), location, user ratings, etc. Furthermore, prioritization may be based on data extracted from the multimedia files themselves. For example, audio files can be analyzed to determine a tempo of a song, and this information may be used in the ordering of songs to be played.

Prioritization may be further performed based on individual user characteristics. For example, users of participant mobile terminals 10B-E may be assigned different characteristics, based on their actions or other characteristics about the users. For example, if a particular participant is highly active, their ‘expected expertise’ may be high. Similarly, people with more music stored in their devices might be considered having more ‘expertise.’ The trustworthiness of a user may also be considered in the ordering of songs. For example, a user may be considered more trustworthy if he or she has previously sent a number of files that were not considered unsuitable.

Participant characteristics may be built up over time and stored in a database, such as database 127, that is accessible by the host terminal 10A. In some embodiments, participant characteristics may be built up using interactive responses/feedback from the participant terminals 10B-E. For example, the multimedia file management modules of the participant terminals 10B-E may include an interface for providing feedback to the host terminal 10A about a current selection. For example, the multimedia file management modules may include an interface capable of providing a user rating (e.g. 1 to 10) that indicates a user's approval or disapproval of a current selection. The response for a particular multimedia selection may be collected and tabulated to provide a metric that is associated with the multimedia file and/or with the participant that submitted the multimedia file. If a particular multimedia file receives high ratings, that file may be given priority in a play list if it is submitted later. Similarly, if a particular user consistently receives high ratings for multimedia files they submit, subsequent submissions by that user may be give higher priority on the play lists. Conversely, if a particular multimedia file receives low ratings, that file may subsequently be given lower priority, and if a user consistently receives low ratings for multimedia files they submit, future submissions by that user may be given lower priority.

Other principles may be used in order to dynamically order a play list. For example, the multimedia file management module of the host terminal may be configured to order play list files to avoid too much repetition in the tempo of songs that are played. For example, the host terminal may be configured to intersperse up-beat (high tempo) and downbeat (low tempo) songs, and/or to provide a desired ratio of high tempo and low tempo songs. In some embodiments, songs may be automatically reordered based on their style classification and/or tempo, so that there is a logical flow with tempo changes. Furthermore, files may be accepted or rejected based on style classification.

In addition, the host terminal 10A may be configured to increase or decrease the priority of multimedia files based on past submission practices of the participant who submits the files. For example, it may be desirable to prioritize submissions by relatively inactive participants in order to encourage more participation. In some cases, it may be desirable to prioritize multimedia files such that no more than a certain number of files from a particular participant are played in a row. Furthermore, non-trustworthy users may be banned altogether.

In some embodiments, images that are sent to the host terminal 10A may be automatically reordered based on time created, and then played in chronological order (as opposed to when users sent the requests to play them). Images from users who have previously sent unsuitable images may automatically be banned. Similarly, video clips may be automatically reordered so that longer and shorter clips are interspersed.

Other rules, mechanisms and approaches to dynamically reordering a multimedia play list will become apparent to a skilled person upon reading this specification.

When the host terminal 10A is in play mode, the controller 30 of the host terminal 10A will identify the multimedia file identification 156A that is to be played thereafter. The multimedia file identification identified may be the multimedia file identification that is to be played next. The host terminal 10A will then send a multimedia file request to the corresponding one of the participant terminals 10B-E to retrieve the multimedia file corresponding to the multimedia file identification.

The corresponding participant terminal will then send a copy of the identified multimedia file (which is stored on the participant terminal) to the host terminal 10A. According to some embodiments, the participant terminal sends the multimedia file to the host terminal 10A as a copy of the multimedia file that is then temporarily stored on the host terminal 10A (e.g., in the memory 34). According to other embodiments, the participant terminal sends the multimedia file to the host terminal 10A as a streaming multimedia file. According to some embodiments, the request and multimedia file signals between the host terminal and the participant terminal are sent wirelessly and, according to some embodiments, via a direct wireless RF connection such as Bluetooth.

The host terminal 10A may inspect the multimedia file to determine if it matches the description provided in the multimedia file identification associated with the file. For example, the host terminal 10A may check to see if the file is of the correct file type and is the correct size. In some cases, and particularly in the case of audio files, the host terminal 10A may consult a local or remote database 127 that contains information about various audio files, such as digital music files, to determine if the multimedia file has the appropriate length, file type and/or name. If the host terminal 10A detects a discrepancy between the information in the multimedia file identification and the actual file, it may, for example, reject the file or flag it for host approval before playing the file.

The controller 30 of the host terminal 10A may then execute playback of the retrieved multimedia file by sending the multimedia file to the media center 130. The multimedia file may be stored on the media center 130 for playback. Alternatively, the multimedia file may be streamed to the media center 130, for example, as the multimedia file is streamed from the originating participant terminal to the host terminal 10A. It may be preferable or necessary to stream the multimedia file from the participant terminal to the host terminal and/or from the host terminal to the media center 130 if the allocated memory space on the host terminal 10A is insufficient and/or storage of the multimedia file on the host terminal 10A is prevented or illegal. According to some embodiments, the multimedia file, whether streamed or stored in whole, may be automatically erased (i.e., without user intervention) from the host terminal 10A during or after playback. In some embodiments, the host terminal 10A may check Digital Rights Management (DRM) information associated with the multimedia file. If the rights attached to the multimedia file are insufficient to support playback of the media by the host terminal 10A and/or the media center 130, the host terminal 10A may send an appropriate notification to the participant terminal 10B-E that submitted the multimedia file and may remove the multimedia file from the play list.

In some embodiments, the multimedia file may be converted by the host terminal 10A to an analog signal for transmission to the media center 130, in which case the media center 130 need not include digital processing circuitry. In other embodiments, the media center 130 may be capable of processing multimedia files having particular formats. For example, the media center 130 may be capable of processing multimedia files having any of a number of standardized file formats, such as MP3, WMF, JPEG, MPEG, etc. However, one or more of the participant terminals 10B-E may have a file stored in a file format that is not supported by the media center 130. In that case, the host terminal 10A may be configured with appropriate coder/decoder (CODEC) software to convert the file format of the multimedia file from the format in which it was provided by the participant terminal 10B-E to a format that is supported by the media center 130 prior to transmitting the multimedia file to the media center 130.

The controller 30 of the host terminal 10A may execute the foregoing steps for each multimedia file identification 156A in turn and automatically (i.e., without user intervention). As the host terminal 10A runs through the multimedia file list 156 in this fashion, the host may modify the play list 156 as desired. Also, according to some embodiments, the participant terminals 10B-E can add new multimedia file identifications to the multimedia file list 156 as the controller 30 of the host terminal 10A runs through the play list 156. According to some embodiments, new participant terminals can join the group and submit multimedia file identifications as the host terminal 10A runs through the play list 156. Such new submissions may be automatically prioritized, for example, according to one or more of the criteria described above.

As discussed above, the host terminal 10A may maintain multiple play lists, for example, one play list for each type of multimedia file. The host terminal 10A may play (or cause the media center 130 to play) multimedia files in the play lists simultaneously and/or sequentially. For example, the host terminal 10A may maintain a play list of still images and a play list of audio files. The host terminal may simultaneously process both play lists, and may, for example, cause the media center 130 to sequentially display images from the image play list on a display while simultaneously causing the media center 130 to sequentially play audio files (e.g., songs) using a speaker system. In some embodiments, the host terminal 10A may process two play lists sequentially. For example, the host terminal 10A may alternate between playing audio files from an audio file play list and video files from a video file play list, so that video files, which typically include an audio track, may not be substantially played at the same time as an audio-only file. It will be understood, however, that the host terminal 10A may be configured to mix audio from an audio file with audio from another audio file or a video file as one file is ending and another is beginning (e.g., a cross-fade).

The host terminal 10A may be configured to alternate one by one between the play lists. Alternatively, the host terminal 10A may be configured, for example, to play a certain number of audio files between each video file. In some embodiments, the relative number of audio files played compared to video files may be based on the number of minutes of content queued in the respective play lists. For example, if the video play list includes 20 minutes of queued video files and the audio play list includes 100 minutes of queued songs, then songs from the audio play list may be played about five times longer than video files from the video play list. Assuming that the songs and the video files have about the same play lengths, the host terminal 10A may play about five songs from the audio play list before switching to the video play list to play a video file.

In the meantime, the host terminal 10A may be configured to display still image files as the audio and video files alternate. In some embodiments, the host terminal 10A may be configured to alternate between playing audio files and displaying still images on the one hand, and playing video files on the other hand.

The system 100A can provide a convenient and enjoyable mechanism for playing multimedia files selected by a group of people, including multimedia files of different types. The system 100A provides playback execution functionality and also allows the host terminal (and, in some cases, the participant terminals) to create, coordinate, control and/or manage the multimedia file play list. In practice, for example, partygoers can add multimedia files from their own participant terminals to a multimedia file play list maintained on a host terminal (e.g., the party host's own mobile terminal). When their multimedia file's turn arrives in the playback sequence, a copy of the multimedia file will automatically be sent to the host terminal and played. Thus, the partygoer need not take any further action. When, in accordance with some embodiments, the request and multimedia file transfer signals are communicated between the host terminal and the participant terminal via a direct wireless connection (e.g., an RF interface such as a Bluetooth connection), the partygoer may simply place his or her participant terminal in a pocket or handbag. Participants may be added and removed as the procedure is executed. For example, when a participant leaves the Bluetooth range, his or her multimedia files may be deleted from or moved down the play list.

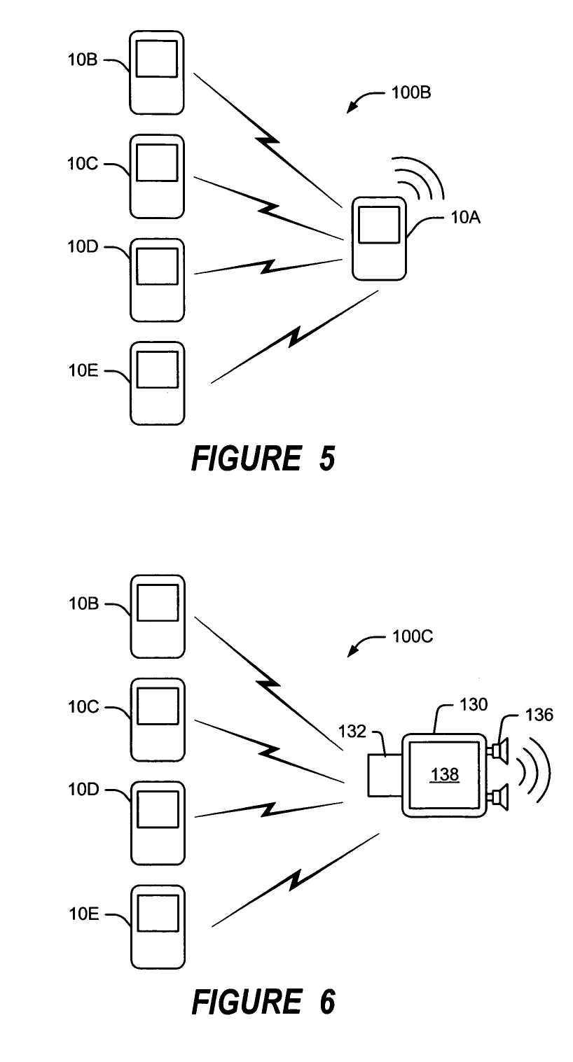

Referring now to FIG. 5, a system 100B according to further embodiments of the present invention is shown therein including the host terminal 10A and the participant terminals 10B-E. The system 100B differs from the system 100A (FIG. 2) in that the media center 130 is omitted and playback of the multimedia files from the multimedia file play list 156 is conducted via the speaker 24 of the host terminal 10A.

Referring now to FIG. 6, a system 100C according to further embodiments of the present invention is shown therein including a media center 130 and the participant terminals 10B-E. The system 100C differs from the system 100B (FIG. 5) in that the play lists are established and maintained by the media center 130 in communication with the participant terminals 10B-E. Furthermore, playback of the multimedia files from the multimedia file play list 156 is conducted via the speaker 136 and/or the video display screen 138 of the media center 130.

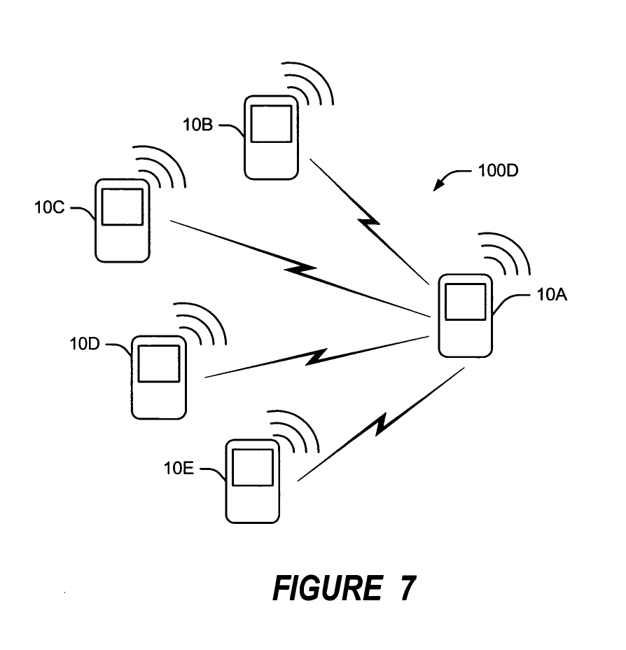

Referring now to FIG. 7, a system 100D according to further embodiments of the present invention is shown therein including the host terminal 10A and the participant terminals 10B-E. The system 100D differs from the system 100B (FIG. 5) in that playback of the multimedia files from the multimedia file play list 156 is conducted via the speaker 24 of the host terminal 10A and, additionally, through the respective speakers of the participant terminals 10B-E and/or through one or more headsets (e.g., in-ear stereo headsets) operatively connected to the participant terminals 10B-E. More particularly, the controller 30 of the host terminal 10A plays each multimedia file in the same manner as described above and also sends the multimedia file to the participant terminals 10B-E for simultaneous playback. Thus, the host terminal 10A creates and manages a multimedia file play list that may include multimedia file identifications from the participant terminals 10B-E, retrieves copies of the multimedia files from the appropriate participant terminals 10B-E as needed, and distributes the copies of the multimedia files to the participant terminals 10B-E for playback. According to some embodiments, the multimedia file transfer signal is sent from the host terminal 10A to the participant terminals 10B-E wirelessly and, according to some embodiments via a direct wireless RF connection such as Bluetooth. According to some embodiments, the multimedia files are streamed to the participant terminals 10B-E. The host terminal 10A may be configured to permit the host to designate which of the participant terminals 10B-E will receive playback signals and which of the participant terminals 10B-E are authorized to submit multimedia file identifications to the play list 156, and these two groups may differ.

The host terminal 10A may be configured to allow the user to selectively choose the device or combination of devices for playback from the various options discussed above. For example, the host terminal 10A may be configured to execute playback via only the speaker 24 of the host terminal 10A, via the speaker of the host terminal 10A and the speakers of the participant terminals 10B-E, via the speakers of the participant terminals 10B-E and the media center 130, etc. It will be appreciated that, when the multimedia files are played back via the speakers of the participant terminals 10B-E, the user of a given one of the participant terminals may disable the speaker thereof and/or may relay the multimedia file for playback on another device (e.g., an associated further media center or the like).

According to further embodiments, the controller 30 of the host terminal 10A may request and/or accept unsolicited a multimedia file catalog listing from a participant terminal. The multimedia file catalog listing includes multimedia file identifications representing each of the multimedia files on the participant terminal or multimedia file identifications for all such multimedia files the participant wishes to make available. The host terminal 10A may thereafter enable the host to select the multimedia file identifications of the multimedia file catalog listing the host wishes to add to the play list.

The application programs described herein, including the multimedia file management module 40, are illustrative of programs that implement various features according to embodiments of the present invention. It will be appreciated that other and/or additional application programs may be employed in accordance with embodiments of the present invention.

Although FIG. 1 illustrates an exemplary hardware/software architecture that may be used in mobile terminals and/or other electronic devices for management and playback of multimedia files, it will be understood that the present invention is not limited to such a configuration but is intended to encompass any configuration capable of carrying out operations described herein. For example, although the memory 34 is illustrated as separate from the controller 30, the memory 34 or portions thereof may be considered as a part of the controller 30. More generally, while particular functionalities are shown in particular blocks by way of illustration, functionalities of different blocks and/or portions thereof may be combined, divided, and/or eliminated. Moreover, the functionality of the hardware/software architecture of FIG. 1 may be implemented as a single processor system or a multi-processor system in accordance with various embodiments of the present invention.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

That which is claimed is:

1. A communication terminal comprising:
a communication module that is configured to communicate with other communication terminals over a communication interface; and
a controller that is configured to establish a connection with a participant communication terminal via the communication module, to maintain a play list representing multimedia files to be played, to receive a participant multimedia file identification from the participant communication terminal and that identifies a participant multimedia file resident on the participant communication terminal, to add the participant multimedia file identification to the play list, to automatically prioritize the play list according to at least one criteria, and to thereafter execute playback of the multimedia files represented by the play list, including retrieving the participant multimedia file from the participant communication terminal for playback.

2. The communication terminal of claim 1, wherein the controller is configured to automatically prioritize the play list based on metadata included in the multimedia file.

3. The communication terminal of claim 2, wherein the controller is configured to automatically prioritize the play list based on a comparison of date created, file format, file size, content rating, or genre associated with the multimedia files listed in the play list.

4. The communication terminal of claim 1, wherein the controller is configured to automatically prioritize the play list based on the tempo of the multimedia files.

5. The communication terminal of claim 1, wherein the controller is configured to automatically prioritize the play list based on an identity of a user of the participant communication terminal.

6. The communication terminal of claim 1, further comprising a database accessible by the controller and configured to store a rating of the user of the participant communication terminal, and wherein the controller is configured to update the rating of the user of the participant communication terminal based on feedback received from other communication terminals in response to playing a multimedia file submitted by the user.

7. The communication terminal of claim 1, further comprising a database accessible by the controller and configured to store a rating of a multimedia file, and wherein the controller is configured to update the rating of the multimedia file based on feedback received from other communication terminals in response to playing the multimedia file.

8. The communication terminal of claim 1, wherein the multimedia file is received from the participant terminal in a first file format, and wherein the controller is further configured to convert the multimedia file to a second file format and to execute playback of the multimedia file in the second file format.

9. The communication terminal of claim 1, wherein the controller is configured to inspect the multimedia file to determine if it matches the description contained in the multimedia file identification and, if the multimedia file does not match the multimedia file identification, to remove the multimedia file from the play list.

10. The communication terminal of claim 1, wherein the play list comprises a first play list configured to list multimedia files of a first type, wherein the controller is further configured to maintain a second play list configured to list multimedia files of a second type, different from the first type.

11. The communication terminal of claim 10, wherein the controller is further configured to play back multimedia files from the first play list and the second play list simultaneously.

12. The communication terminal of claim 10, wherein the controller is further configured to alternate between play back of multimedia files from the first play list and the second play list.

13. The communication terminal of claim 1, wherein the controller is configured to establish a connection with a plurality of participant communication terminals via the communication module, to receive a plurality of participant multimedia file identifications from the plurality of participant communication terminals, wherein each participant multimedia file identification corresponds to a respective participant multimedia file resident on a respective one of the plurality of participant communication terminals, to add each of the participant multimedia file identifications to the play list, and to retrieve the participant multimedia files from each of the respective participant communication terminals for playback.

14. The communication terminal of claim 1, wherein the controller is configured to retrieve and execute the participant multimedia file from the participant communication terminal as a streaming file.

15. The communication terminal of claim 1, wherein the controller is configured to retrieve the participant multimedia file from the participant communication terminal, to store the participant multimedia file on the communication terminal, and to thereafter execute playback of the stored participant multimedia file.

16. The communication terminal of claim 1, wherein the controller is configured to send a playback signal to a media center for playback of the multimedia files represented by the play list on the media center.

17. The communication terminal of claim 16, wherein at least one of the multimedia files is received from the participant terminal in a first file format, and wherein the controller is further configured to convert the multimedia file to a second file format and to send the playback signal to the media center in the second file format.

18. The communication terminal of claim 16, wherein the playback signal comprises an analog signal.

19. The communication terminal of claim 1, including a speaker and a display screen, and wherein the controller is configured to play the multimedia files represented by the play list using the speaker and/or the display screen.

20. The communication terminal of claim 1, wherein the controller is configured to send a playback signal to at least one participant communication terminal for playback of the multimedia files represented by the play list on the at least one participant communication terminal.

21. The communication terminal of claim 1, wherein the controller is configured to receive a multimedia catalog listing from the participant communication terminal representing available multimedia files stored on the participant communication terminal, to receive user input selecting from the available multimedia files, and to add the selected available multimedia files to the play list.

22. The communication terminal of claim 1, wherein the controller is configured to send a listing signal to the participant communication terminal representing the play list for display of the play list on the participant communication terminal.

23. The communication terminal of claim 1 wherein:
the communication module is configured to communicate with other communication terminals over a direct point-to-point interface; and
the controller is configured to establish the connection with the participant communication terminal via the communication module, receive the participant multimedia file identification from the participant communication terminal, and retrieve the participant multimedia file from the participant communication terminal for playback all via the direct point-to-point interface.

24. The communication terminal of claim 1, wherein the communication module comprises a short range transmitter, and the controller is configured to establish the connection with the participant communication terminal, receive the participant multimedia file identification from the participant communication terminal, and retrieve the participant multimedia file from the participant communication terminal for playback all via the short range transmitter.

25. The wireless communication terminal of claim 1, wherein the communication module comprises a wireless communication module, and wherein the controller is configured to establish a wireless connection with the participant communication terminal via the wireless communication module.

26. A method for providing a multimedia play list using a host communication terminal, the method comprising:
establishing a connection between the host communication terminal and a participant communication terminal;
maintaining a play list using the host communication terminal, the play list representing multimedia files to be played;
receiving at the host communication terminal a participant multimedia file identification from the participant communication terminal, wherein the participant multimedia file identification corresponds to a participant multimedia file stored on the participant communication terminal;
adding the participant multimedia file identification to the play list;
automatically prioritizing the play list according to at least one criteria; and thereafter
executing playback of the multimedia files represented by the play list, including retrieving the participant multimedia file from the participant communication terminal for playback.
